(19) United States
(12) Patent Application Publication
(10) Pub. No.: US 2019/0144204 A1
(43) Pub. Date: May 16, 2019

(54) RECEPTACLE FOR WASTE MATERIAL

(71) Applicant: HEARTLAND WOODCRAFT, INC., West Bend, WI (US)

(72) Inventors: WILLIAM B BRENCKLE, Kewaskum, WI (US); Patrick J Koness, Pewaukee, WI (US)

(73) Assignee: HEARTLAND WOODCRAFT, INC., West Bend, WI (US)

(21) Appl. No.: 16/188,226

(22) Filed: Nov. 12, 2018

Related U.S. Application Data
(60) Provisional application No. 62/586,583, filed on Nov. 15, 2017.

(51) Int. Cl. B65F 1/16; B65F 1/14

(52) U.S. Cl. CPC B65F 1/163; B65F 1/1426; B65F 2250/114; B65F 2250/11; B65F 2250/128

(57) ABSTRACT

A receptacle for waste material is disclosed. The receptacle may comprise a cabinet/structure with a hinged/flip door actuated by an actuator such as a foot plate/pedal. Items of waste material may be deposited into the receptacle (e.g. in a hands-free action) through an opening at the flip door actuated from a closed position toward an open position by movement of the foot pedal from a default position to an actuated position. The receptacle may comprise an actuation mechanism such as a linkage/link assembly coupling the flip door to the foot pedal; the mechanism may be configured to shield/cover the linkage from contact with items of waste material. The link/link assembly may comprise a rigid member such as a rod coupled to the side of the flip door and the side of the foot pedal (or to each side of the flip door and the foot pedal). Actuation/action of the flip door with the mechanism may be modified by design/configuration of the foot plate/pedal and design/configuration of the flip door. An internal bin or liner may be provided within the receptacle.

### CROSS-REFERENCE TO RELATED APPLICATIONS

The present application claims priority to and incorporates by reference in full the following patent application: U.S. Provisional Patent Application No. 62/596,583 titled “RECEPTACLE FOR WASTE MATERIAL” filed Nov. 15, 2017.

### FIELD

The present invention relates to a receptacle for waste material.

### BACKGROUND

It is known to provide a receptacle for waste material. Such known receptacles for waste materials as presently understood present various limitations and the opportunity for modification and improvements.

It would be advantageous to provide an improved receptacle for waste material that comprises a cabinet/structure with a hinged/flip door actuated by a foot pedal so that items of waste material may be deposited into the receptacle (e.g. in a hands-free action) through an opening at the flip door when actuated from a closed position to an open position by the foot pedal. It would also be advantageous to provide a receptacle with an actuation mechanism such as a linkage coupling the flip door to the foot pedal and in which the linkage is shielded from contact with items of waste material. It would further be advantageous to provide an improved receptacle for waste material that comprises at least one or more of the features and other inventive concepts shown and described in the FIGURES and specification.

### SUMMARY

The present invention relates to a receptacle for waste material comprising (a) a top; (b) a body configured to provide an interior; (c) a base for the body configured to provide a recess; (d) a door under the top configured to move between a closed position and an open position to facilitate access into the interior of the body; (e) an actuator mounted in the recess of the base and configured to move between a default position and an actuated position; and (f) a link coupling the actuator to the door. The actuator may be configured for manual actuation to move between the default position and the actuated position to move the door from the closed position toward the open position so that waste material may be deposited within the interior of the body.

The door of the receptacle may comprise a flip door pivotally coupled to the body and configured to pivot from a generally vertical orientation in the closed position toward the interior of the body to the open position; and the actuator may comprise a plate at least partially within the recess and pivotally coupled to the base.

The actuator may comprise a foot pedal in the recess in the base and pivotally coupled within the base. The link may comprise a member coupled at one end to the foot pedal and coupled at one end to the door. The member may comprise a rigid member configured to couple the foot pedal directly to the door. The member may comprise a post configured to engage a side of the door and a post configured to engage a side of the foot pedal. The receptacle may comprise a frame member providing a slot; and the post of the member configured to engage the side of the door may extend through the slot.

The receptacle may comprise a frame member providing a slot; the link may comprise a member coupled at one end to the foot pedal and coupled at one end to the door; and the one end of the member coupled to the foot pedal may extend through the slot of the frame member. The receptacle may comprise a body providing a side panel; the side panel may comprise a recess for the link; the link may comprise a member at least partially within the recess of the side panel; the receptacle may comprise a cover plate at least partially covering the recess for the link in the side panel of the body.

The body may comprise an access door under the flip door configured to facilitate access to a bin for waste material within the interior of the body. The base may comprise a frame. The body may comprise a cabinet comprising at least one of (a) a wood material; (b) a metal material; (c) a plastic material; the base may comprise at least one of (a) a metal frame; (b) a wood material; and the top may comprise at least one of (a) a wood material; (b) resin material.

The present invention also relates to a receptacle for waste material comprising: (a) a top; (b) a body configured to provide an interior; (c) a base for the body configured to provide a recess; (d) a door under the top configured to pivot from a generally vertical orientation in the closed position to an open position toward the interior of the body to facilitate access into the interior of the body; (e) a foot plate coupled in the recess of the base and configured to pivot between a default position and an actuated position; and (f) a link assembly coupling the foot plate to the door. The foot plate may be configured for manual actuation to pivot between the default position and the actuated position to pivot the door from the closed position toward the open position so that waste material may be deposited within the interior of the body. The link assembly may comprise a rigid member directly coupling the foot plate to the door and comprising a frame member for the rigid member. The link assembly may comprise (1) a first member providing an end configured to engage a first side of the door and an end configured to engage a first side of the foot plate and (2) a second member providing an end configured to engage a second side of the door and an end configured to engage a second side of the foot plate.

The present invention further relates to an apparatus for depositing waste material comprising: (a) a top; (b) a cabinet comprising at least one side panel and configured to provide a body having an interior configured for a bin; (c) a base under the body configured to provide a recess; (d) a door under the top configured to pivot from a generally vertical orientation in the closed position to an open position toward the interior of the body to facilitate access into the interior of the body; (e) a foot plate coupled to the base in the recess and configured to pivot between a default position and an actuated position; and (f) a link assembly coupling the foot plate to the door. The link assembly may comprise a member installed at least partially within a recess in the side panel of the cabinet. The foot plate may be configured for manual actuation to pivot between the default position and the actuated position to pivot the door from the closed position toward the open position so that waste material may be deposited into the bin within the interior of the body. The apparatus may comprise a cover plate at least partially covering the recess for the member of the link assembly in the side panel of the cabinet. The member of the link assembly may comprise a rod providing an end configured to engage a side of the door and an end configured to engage a side of the foot plate. The foot plate may comprise a pedal pivotally coupled to the base on an axle; the door may comprise a flip door pivotally coupled to the base on an axle.

The present invention further relates to an improved receptacle for waste material that comprises a cabinet/structure with a hinged/flip door actuated by a foot pedal so that items of waste material may be deposited into the receptacle (e.g. in a hands-free action) through an opening at the flip door when actuated from a closed position to an open position by the foot pedal (e.g. maintained in open position until items or waste are deposited into the interior bin); the receptacle comprises an actuation mechanism such as a linkage coupling the flip door to the foot pedal; the receptacle may conceal or shield the linkage from contact with items of waste material. Actuation/action of the flip door with the mechanism may be modified by design/configuration of the foot plate/pedal and design/configuration of the flip door and design/configuration of the linkage.

The present invention relates to an improved receptacle for waste material that comprises at least one or more of the features (including combinations) and other inventive concepts shown and described in the FIGURES and specification.

### FIGURES

FIGS. 1A through 1F are schematic perspective views of a receptacle for waste material in use/operation according to an exemplary embodiment.

FIGS. 2A through 2F are schematic perspective views of a receptacle for waste material according to an exemplary embodiment.

FIG. 3A is a schematic perspective exploded view of a receptacle for waste material according to an exemplary embodiment.

FIG. 3B is a schematic perspective partial exploded view of an actuation mechanism for receptacle for waste material according to an exemplary embodiment.

FIG. 3C is a schematic perspective partial exploded view of an actuation mechanism for the receptacle for waste material according to an exemplary embodiment.

FIG. 3D is a schematic cross-section view of the receptacle for waste material according to an exemplary embodiment.

FIG. 3E is a schematic front elevation cross-section view of the receptacle for waste material according to an exemplary embodiment.

FIG. 3F is a schematic partial cross-section view of actuation mechanism of the receptacle for waste material according to an exemplary embodiment.

FIG. 4A is a schematic perspective view of a receptacle for waste material according to an exemplary embodiment.

FIGS. 4B through 4F are schematic perspective views of the interior of a receptacle for waste material according to an exemplary embodiment.

FIGS. 5A and 5B are schematic perspective partial views of the actuation mechanism of a receptacle for waste material according to an exemplary embodiment.

FIGS. 6A and 6B are schematic perspective partial views of the actuation mechanism of a receptacle for waste material according to an exemplary embodiment.

FIGS. 7A and 7B are schematic perspective views of an actuation mechanism for receptacle for waste material according to an exemplary embodiment.

FIG. 8 is a schematic perspective partial exploded view of an actuation mechanism for a receptacle for waste material according to an exemplary embodiment.

FIGS. 9A and 9B are schematic perspective partial views of the actuation mechanism for a receptacle for waste material according to an exemplary embodiment.

FIG. 10 is a schematic perspective partial exploded view of the actuation mechanism for a receptacle for waste material according to an exemplary embodiment.

FIGS. 11A through 11E are schematic side elevation views of the actuation of a receptacle for waste material according to an exemplary embodiment.

FIGS. 11F and 11G are schematic side elevation partial views of the actuation of a receptacle for waste material according to an exemplary embodiment.

FIG. 12A is a schematic exploded perspective view of a hinge/flip door of a receptacle for waste material according to an exemplary embodiment

FIGS. 12B through 12D are schematic perspective views of the hinge/flip door of a receptacle for waste material according to an exemplary embodiment.

FIGS. 13A through 13H are schematic perspective partial views of the attachment arrangement for the hinge/flip door of a receptacle for waste material according to an exemplary embodiment.

FIGS. 14A, 14C, 14E and 14G are schematic perspective views of the foot plate/pedal of a receptacle for waste material according to an exemplary embodiment.

FIGS. 14B, 14D, 14F and 14H are schematic perspective partial views of the foot plate/pedal of a receptacle for waste material according to an exemplary embodiment.

FIGS. 15A and 15B are schematic perspective views of the hinge/flip door of a receptacle for waste material according to an exemplary embodiment.

FIGS. 16A and 16B are schematic perspective partial views of the hinge/flip door of a receptacle for waste material according to an exemplary embodiment.

FIG. 17A is a schematic perspective view of an actuation mechanism for receptacle for waste material according to an exemplary embodiment.

FIG. 17B is a schematic perspective exploded view of an actuation mechanism for receptacle for waste material according to an exemplary embodiment.

FIGS. 18 and 19 are schematic perspective partial exploded views of the actuation mechanism of a receptacle for waste material according to an exemplary embodiment.

FIGS. 20A through 20E are schematic side elevation views of the actuation of a receptacle for waste material according to an exemplary embodiment.

FIG. 21 is a schematic side elevation view of the actuation of a receptacle for waste material according to an exemplary embodiment.

FIGS. 22A through 22D are schematic perspective partial views of the foot plate/pedal of a receptacle for waste material according to an exemplary embodiment.

FIGS. 23A and 23B are schematic side elevation views of the actuation of a receptacle for waste material according to an exemplary embodiment.

FIGS. 24A and 24B are schematic side elevation partial views of a receptacle for waste material according to an exemplary embodiment.

FIG. 25A is a schematic perspective view of a receptacle for waste material according to an exemplary embodiment.

FIG. 25B is a schematic perspective partial exploded view of a receptacle for waste material according to an exemplary embodiment.

FIG. 25C is a schematic perspective partial view of an actuation/linkage mechanism for a receptacle for waste material according to an exemplary embodiment.

FIG. 25D is a schematic perspective partial exploded view of an actuation mechanism for a receptacle for waste material according to an exemplary embodiment.

FIG. 25E is a schematic perspective view of the foot plate/pedal of a receptacle for waste material according to an exemplary embodiment.

FIG. 25F is a schematic perspective partial view of the foot plate/pedal of a receptacle for waste material according to an exemplary embodiment.

### DESCRIPTION

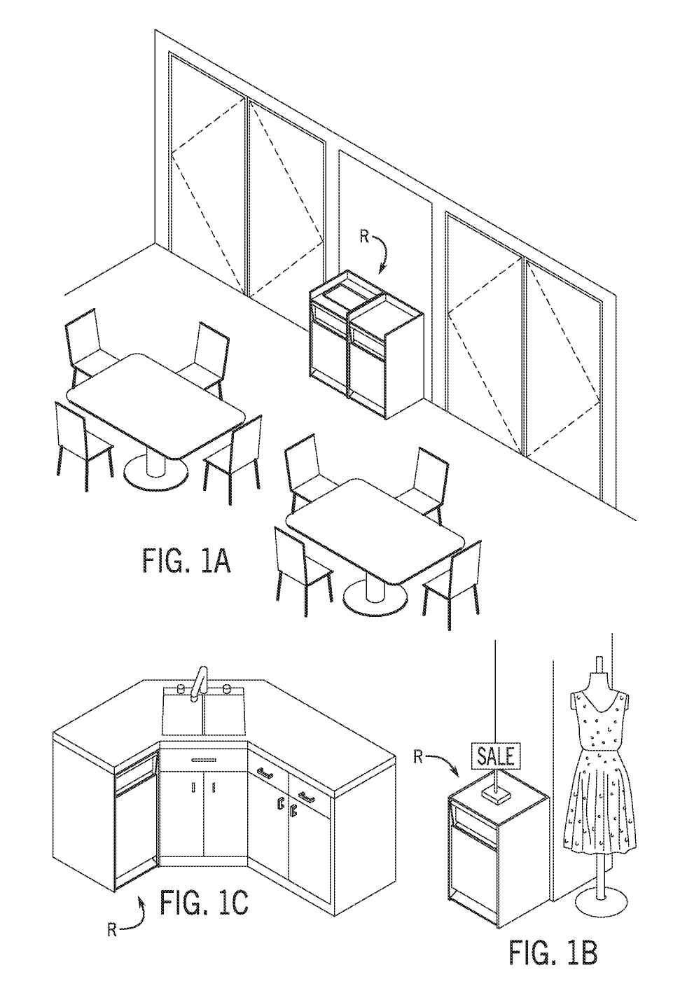

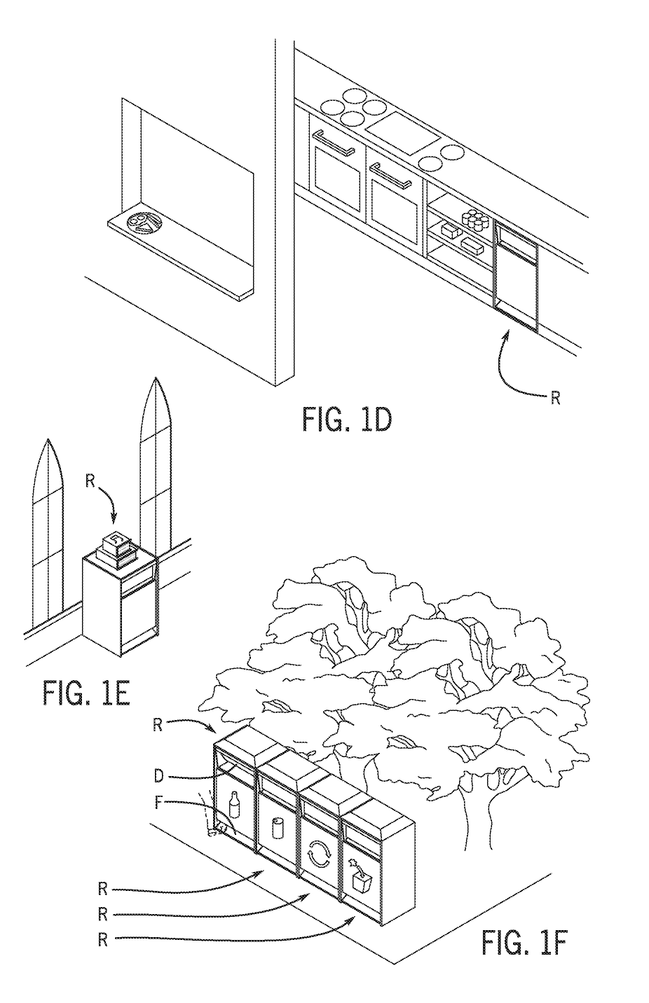

Referring to FIGS. 1A through 1F, a receptacle for waste material is shown schematically according to an exemplary embodiment in multiple applications and environments. As shown schematically in FIG. 1A the receptacle may be used in a food service/restaurant environment (e.g. cafeteria, fast food restaurant, family restaurant, food court, etc.). As shown schematically in FIG. 1B, the receptacle may be used in a commercial/retail environment (e.g. retail store, market/supermarket, mall, convenience store, etc.). As shown schematically in FIG. 1C, the receptacle may be used in a home/apartment or residential environment (e.g. kitchen of family home, dining/entertainment area, dinette, apartment/flat, etc.). As shown schematically in FIG. 1D the receptacle may be used in a food service area or commercial/industrial kitchen environment (e.g. restaurant, commercial cafeteria, dining hall, etc.). As shown schematically in FIG. 1E, the receptacle may be used in an institutional/educational, public, transportation center, business/commercial, or industrial/factory or shared/office environment (e.g. school/university, religious institution, transit station/airport, correctional facility, municipal center, office area, laboratory, hospital, medical center/office, training center, meeting area, reception area/lobby, vestibule/hallway, entry/foyer, etc.). As shown schematically in FIG. 1F, the receptacle may be used in a municipal or recreational environment (e.g. park, arena/stadium, convention center, theatre, public gathering area, showroom, walkway/sidewalk, auditorium, rest stop, etc.). As indicated generally and schematically, according to an exemplary embodiment the receptacle may be used in a wide variety of environments to provide an aesthetically-pleasing structure and convenient/sanitary experience (e.g. for self-service disposal and/or concealed management of items of waste material, trash, etc.).

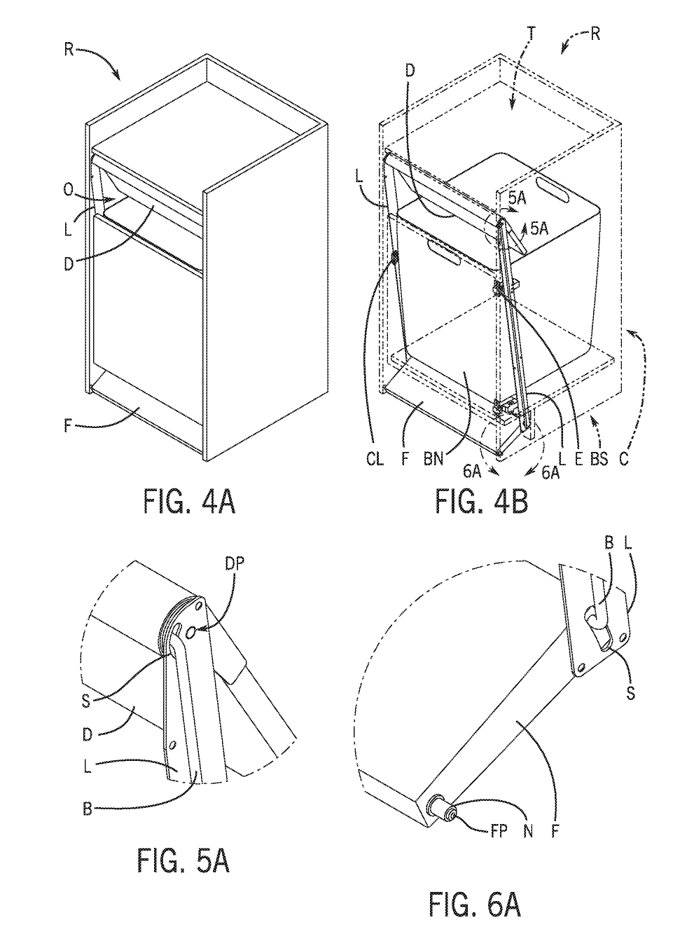

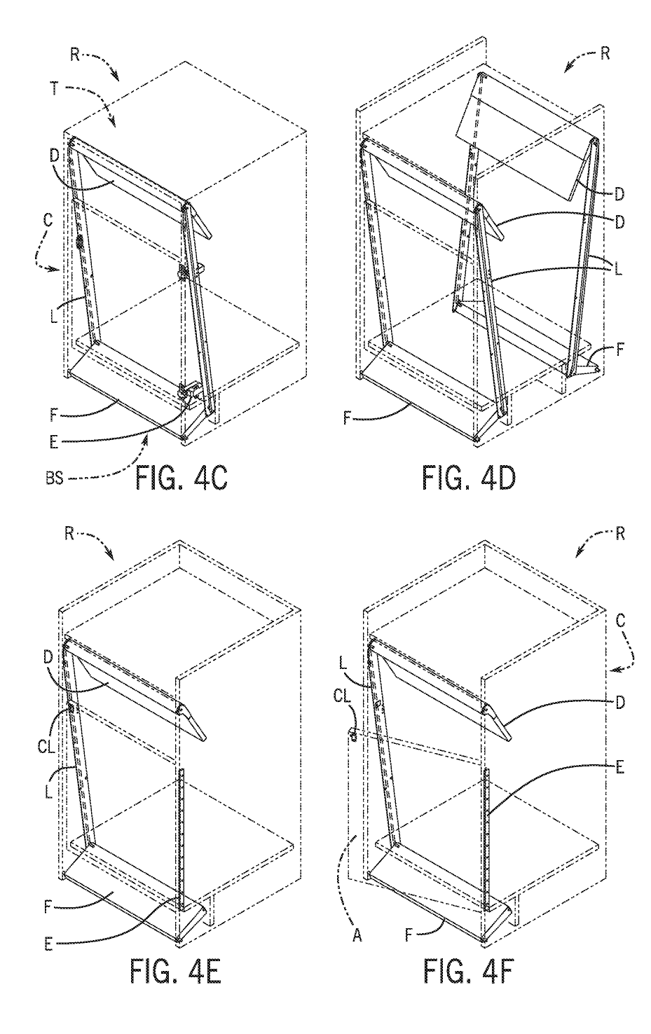

As indicated schematically according to an exemplary embodiment in FIGS. 1A-1F, the receptacle for waste material presents a face (e.g. front or side) that provides a door shown as hinged/flip door actuated by a foot plate/pedal (e.g. foot-operated actuator, kick plate, etc.) and that may be operated for convenient hands-free self-service waste disposal (e.g. by customers, employees, visitors, etc.) in the environment or application. As indicated schematically in the FIG. 1A through 1F, the receptacle may be provided as a self-standing unit and/or integrated with other structures (e.g. cabinetry, walls, etc.); the receptacle may be provided as a single unit or in a group of multiple units (e.g. facilitating functionality and convenient use in the environment). See also FIG. 4D (receptacle may be provided as a single unit with multiple/dual flip doors, e.g. on opposing sides of the structure).

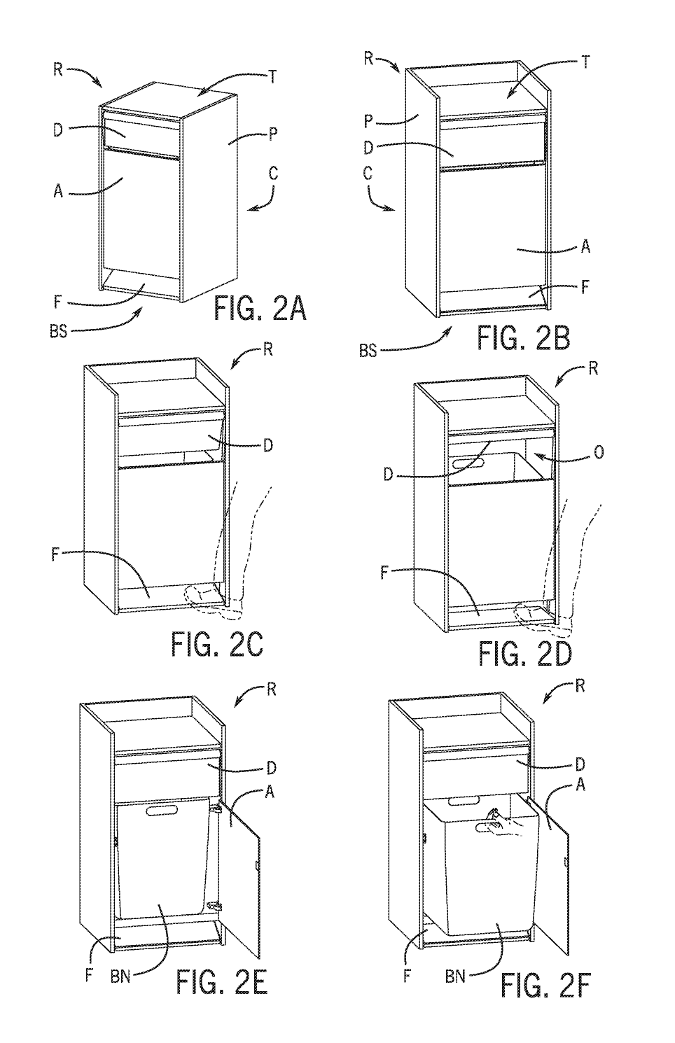

According to an exemplary embodiment, the receptacle is configured for convenient hands-free (e.g. “no-touch”) use in the application with the flip door being fully opened by actuation at the foot plate/pedal (and conveniently able to be maintained in the open position) for disposal of items of waste material (e.g. to facilitate fast/convenient disposal of items on a tray, by hand dropping/tossing, etc. into the opening of the receptacle without touching any part of the receptacle by hand or any direct contact with the flip door); the swinging/flip door is manually operated with the foot plate/pedal for convenient and efficient use (e.g. with the hinged/flip door maintained in open position until items of waste are fully deposited into the interior bin without moving to the closed position prematurely and reducing likelihood of items of waste being dropped other than inside the interior bin of the receptacle); the receptacle comprises an actuation mechanism such as a linkage coupling the flip door to the foot pedal; the receptacle may conceal or shield the linkage from contact with items of waste material (e.g. intended to prevent exposure, contact, fouling, contamination, wear, interference/inhibition, etc. of the mechanism/linkage and intended to promote ease of maintenance/cleaning of the receptacle). See e.g. FIGS. 1A-1F, 3A-3F, 11E and 20E. According to an exemplary embodiment shown schematically, the receptacle is configured and/or installed so that the foot plate F is positioned within (e.g. wholly or substantially) the bottom/base section of the receptacle R (e.g. as to facilitate clean-up and as not to present a prominent extension as may be a trip hazard). See e.g. FIGS. 1A-1F, 11A-11E, 20A-20E and 23A-23B. As indicated schematically according to an exemplary embodiment, the receptacle may be provided with a removable liner (e.g. interior bin/liner, internal container, etc.) and access door (e.g. hinged front, cabinet door, etc.) facilitating ease of access for maintenance/removal of items of waste that have been disposed into the receptacle through the opening created by actuation of the flip door by the foot pedal (e.g. actuated to a fully open position hinged to approximately 90 degrees more or less from the closed position to reduce obstruction in the opening). See e.g. FIGS. 2C-2F, 4B-4F and 11F-11G.

As indicated schematically in FIGS. 1A-1F and 2A-2B, the receptacle may be provided in multiple configurations and sizes (e.g. height, width, depth) and forms (e.g. shape, profile, footprint, exterior configurations, access arrangements, etc.) that may be suited for a wide variety of uses and applications. As indicated schematically in FIGS. 1A through 1F, according to an exemplary embodiment the receptacle with flip door D and actuator shown as foot plate F may be provided in sizes and forms and configurations to facilitate use and convenient deposit of a wide variety of items of waste material in a wide variety of uses and applications; as shown schematically, the receptacle arrangement may comprise one or multiple receptacles in a closely situated or connected arrangement or integrated within other furniture or surroundings (e.g. to facilitate sanitary and convenient disposal of items of waste material in an industrial/commercial environment, to facilitate sanitary and convenient disposal of items in a retail/food service environment, to facilitate organized/sorted disposal of items of waste material such as to facilitate recycling, etc.). As indicated schematically in the FIGURES, the structure and configuration of the receptacle may comprise the use of a wide variety of materials that are selected/suited for the application (e.g. wood, plastic, recycled plastic, fiberglass, metal, stainless steel, composites, concrete, carbon fiber, etc.). According to an exemplary embodiment, the receptacle may be constructed of a material (such as stainless steel, etc.) or combination of materials suitable for environments requiring sanitary/sterile environmental conditions (e.g. commercial/industrial food service/kitchen, laboratory, hospital, medical center, clean room, etc.) and configured to facilitate suitable disposal of items of waste material. Items of waste material for the receptacle according to an exemplary embodiment may comprise any of a wide variety of materials including but not limited to common trash, waste paper, food waste, biological material, clothing, office waste, paper, recyclable materials, plastics, glass, etc.

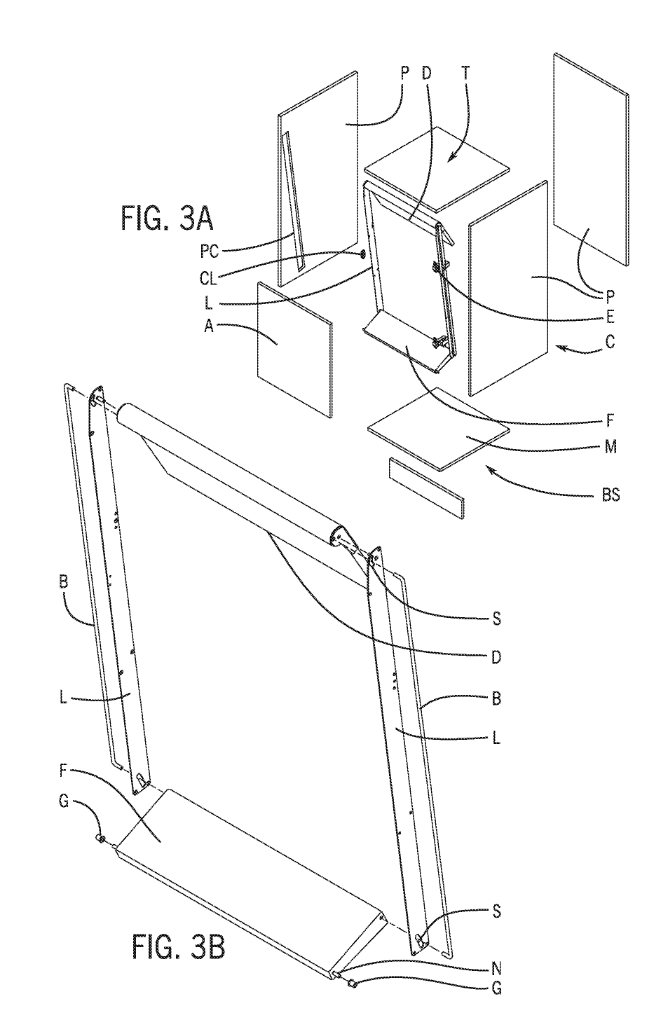

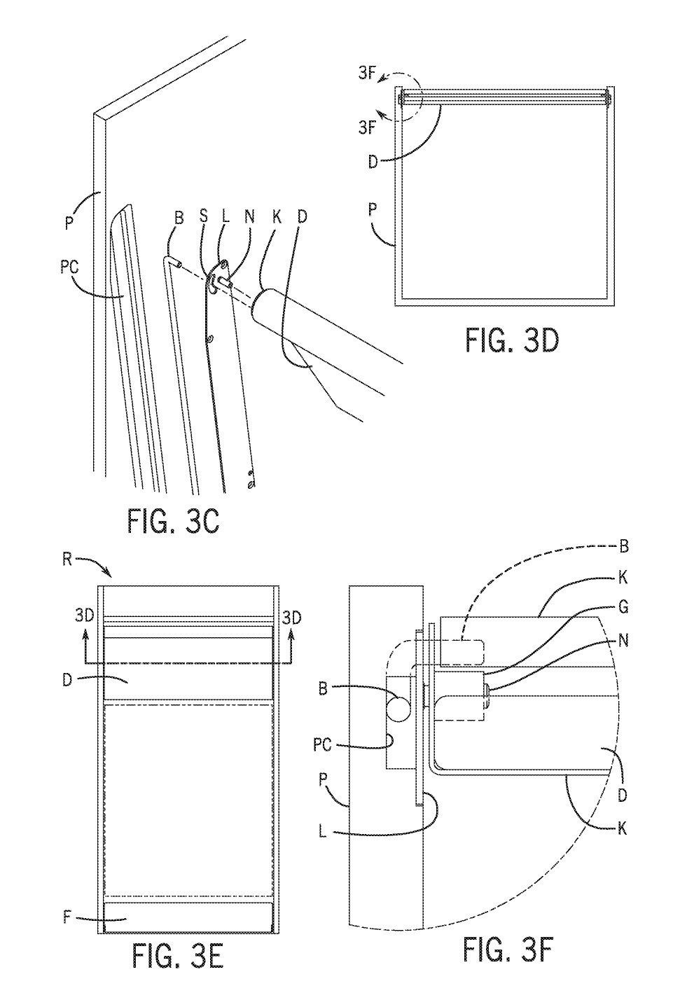

Referring to FIGS. 2A through 2F, as shown schematically according to an exemplary embodiment, the receptacle may comprise a structure shown as comprising a body shown as a cabinet C formed from panels P with a base BS and a top T above a door shown as flip door D and a door shown as access door A and a door shown as flip door D with an actuator shown as foot-actuated pedal F at the bottom M of the structure operating through a mechanism shown as comprising a linkage. See also FIGS. 3A-3B and 4A-4F. As indicated schematically, the panels of the cabinet/structure may be secured by any of a variety of techniques (e.g. secured by fasteners, adhesives, other forming arrangements/combinations, integrally-formed, etc.). As indicated schematically in FIGS. 1A-1F and 2A-2F, the top of the receptacle/structure may be provided in multiple configurations such as with a top T that may provide a generally horizontal surface for items such as trays, signage, books, other materials, etc. See e.g. FIGS. 1A-1B, 2A-2B, 24A-24B and 25A-25B. According to an exemplary embodiment as shown schematically in FIGS. 1A, 2B-2F and 24A, the top T of the receptacle may be provided with sidewalls; as shown schematically in FIGS. 1B-1F, 2A and 24B, the top T of the receptacle may be provided without sidewalls (e.g. such as a standard or flat top as may be configured in a manner as to facilitate installation in other furniture, shelving, under a counter, etc.).

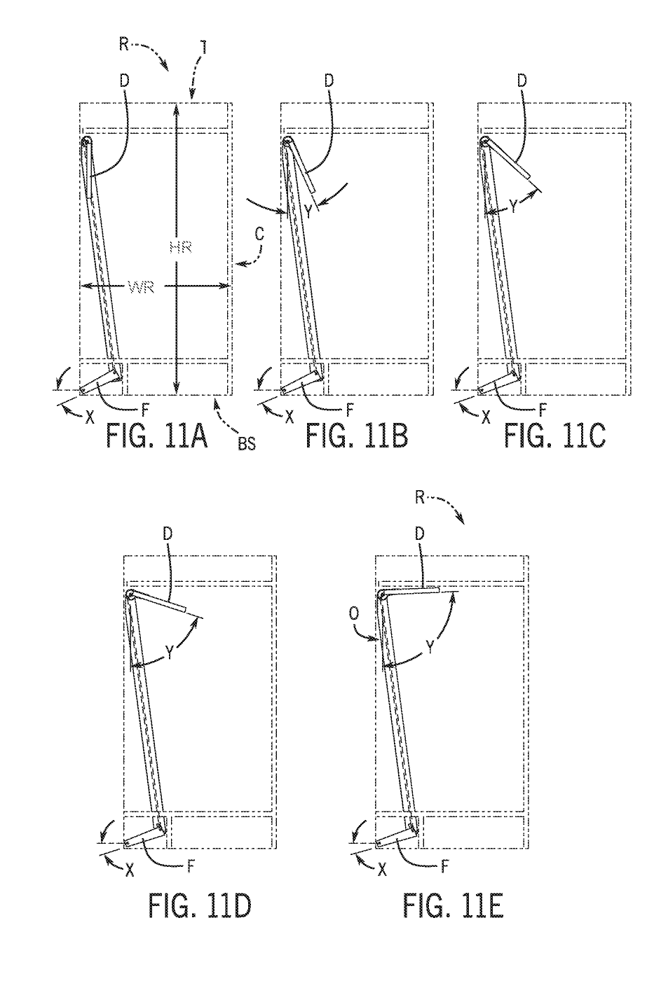

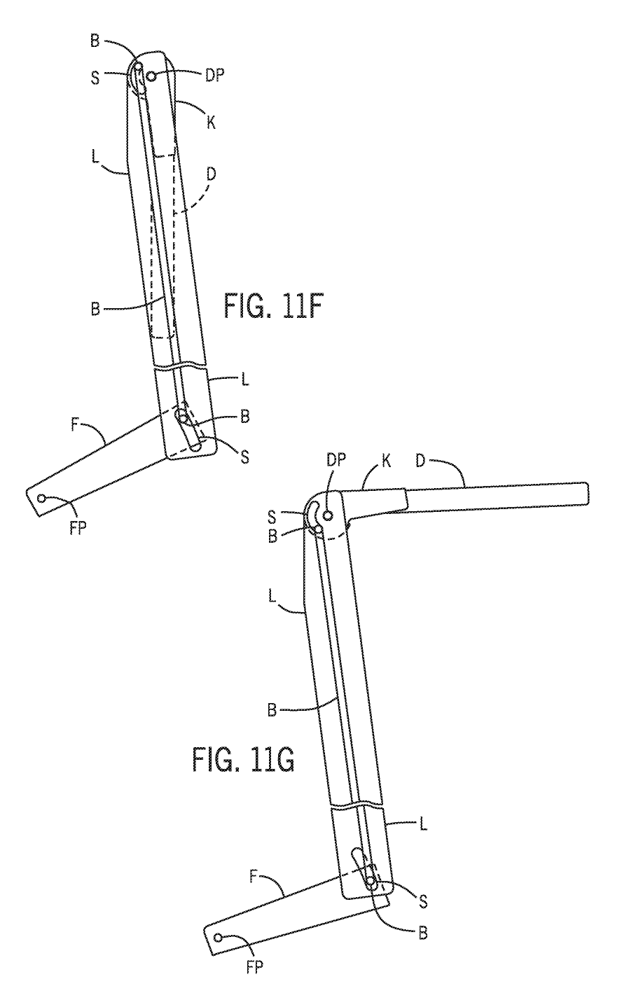

Referring to FIGS. 3A and 3B, as shown schematically according to an exemplary embodiment, the cabinet C of the receptacle comprises panels P with a top T and base BS and bottom M (provided for the internal bin and including a panel or toe kick as indicated to form under the base a space for the actuator/pedal) with an access door A secured by a hinge arrangement E with a latch or closure CL (e.g. access to an internal bin). See also FIGS. 4A-4F. As shown schematically according to an exemplary embodiment, the receptacle/structure (e.g. assembly of the panels, top, bottom, doors, etc.) will provide an internal volume for movement of the flip door (e.g. to allow deposit of items of waste material) and for the internal bin (e.g. shown as bin/liner BN provided behind the access door for receiving items of waste material) and a space for the foot pedal (e.g. provided to contain and allow access for actuation of the flip door) of the receptacle. See FIGS. 2C-2D and 11A-11E. As shown schematically according to an exemplary embodiment in FIGS. 3A and 3B, the mechanism for the receptacle comprises a link assembly/linkage that when installed is concealed/shielded (at least partially) in a recess PC in panel P (e.g. in typical use protected/shielded from fouling, contamination, interference, etc. by items of waste material deposited into the opening of the receptacle). See also FIGS. 3C through 3F (e.g. showing a frame member/cover plate L for arm/rod/member B of link assembly/linkage coupling the door D to the actuator/pedal F).

As shown schematically according to an exemplary embodiment in FIGS. 24A and 24B, the front of the cabinet/structure may provide a front apron FA at the opening O (e.g. a panel or facing to visually conceal and/or to block physical access to the hinge/pivot area of the flip door).

As indicated schematically in FIGS. 2E and 2F according to an exemplary embodiment, access door A is provided to allow access to the bin BN into which waste material is deposited (e.g. for emptying, cleaning, maintenance, etc.); as indicated schematically, access door A is mounted to the cabinet/structure on a hinge arrangement E (e.g. shown as cabinet hinges) and may be provided with a latch/catch arrangement CL (e.g. magnetic latch set, push-push latch mechanism, detent mechanism, spring latch, magnetic catch, elbow catch, etc.). See FIGS. 4A-4C. See also FIGS. 4E-4F (showing piano hinge arrangement E and door catch mechanism CL for access door A). As indicated schematically in FIGS. 2E-2F and 4C-4F, the access door arrangement of the receptacle R may be provided in a variety of different forms. As shown schematically in FIG. 4C, the access door may be mounted on a pair of cabinet hinges with a catch CL (e.g. magnetic latch, stop, etc.). As shown schematically in FIGS. 4E and 4F the access door of the receptacle may comprise a hinge shown as piano hinge E. As shown schematically according to an exemplary embodiment in FIG. 4D, the receptacle R may comprise a cabinet/structure with a two door/dual-door arrangement for flip doors D with a single shared bin/liner (e.g. front/rear or dual side) providing a dual set of openings for depositing of items of waste material (e.g. double-sided access provided by two openings); according to an exemplary embodiment, the dual flip door arrangement may be provided with one access door or multiple access doors.

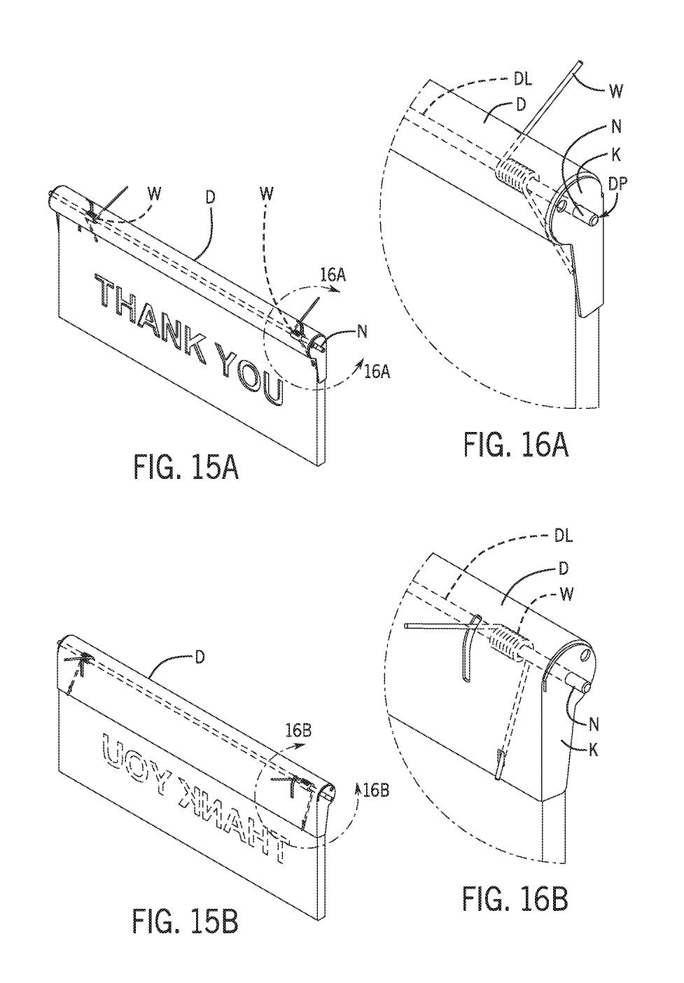

According to an exemplary embodiment as indicated schematically in FIGS. 4A-4F, 6A-6B and 10, the foot plate F is secured to the structure of the receptacle by an axle and/or arrangement with pins N seated in a recess/mounting (e.g. such as bearing G in side panels P, fixed pins in side panels with bearing in foot plate, etc.) for pivotal movement in use/operation. See FIGS. 3A-3B, 14A-14F, 17A-17B, 19, 22A-22D and 25C. See also FIGS. 11A-11G. According to an exemplary embodiment as indicated schematically in FIGS. 3A-3F, 4A-4F, 12D, 13D, 13H and 18, the flip door D is secured to the structure of the receptacle (e.g. directly or indirectly in a recess in panel/mechanism with cover plate L) by an axle and/or arrangement with pins N (e.g. seated in a mounting such as with bearings G, fixed pins on cover plate or panel with seat/bearings in flip door, etc.) for pivotal movement in use/operation. See FIGS. 15A-15B and 16A-16B. See also FIGS. 11A-11G. As indicated schematically according to an exemplary embodiment shown in FIGS. 7A-7B, the flip door D may be provided with pads or stops shown as bumpers MB (e.g. one or multiple rubber/elastomeric pads, shields, single strip of material, etc.) configured to make contact with the interior of the top of the cabinet/structure (e.g. absorbing impact, reducing sound in use, reducing effects of wear/use, etc.); as indicated, the stop/bumper arrangement may comprise one or multiple pads/stops installed on the flip door or within the interior structure of the receptacle to shield impact of the flip door with the interior structure of the receptacle.

As shown schematically in FIGS. 2C and 2D, in operation/use of the receptacle, the door shown as flip door D is actuated using an actuator shown as foot plate or pedal F; in operation/use, foot pedal F is actuated (e.g. pivoted, pressed/depressed, lowered, lifted, etc. according to the configuration) by a user to pivot the flip door D from a generally vertical orientation (e.g. a closed position) to a generally horizontal orientation (e.g. an open position) establishing an opening O under the flip door D with access to the contained bin BN within the cabinet/structure of receptacle R; items of waste material/waste intended for the receptacle may then be deposited through the opening O at the flip door D and into an internal bin BN of the receptacle. See also FIGS. 11A-11E, 20A-20E, 21, 23A-23B and 25A-25C.

As shown schematically in FIGS. 1A-1F, 2A-2B, 7A and 11A, when the receptacle is not in use (e.g. in the absence of actuation of the foot pedal) the flip door is closed (e.g. in the generally vertical orientation as retained by weight/gravity, e.g. pivoted to hang downward and/or into a stop). See also FIGS. 15A-15B and 16A-16B (spring-assist mechanism with spring W to apply a force to retain/bias the flip door in the closed/vertical position).

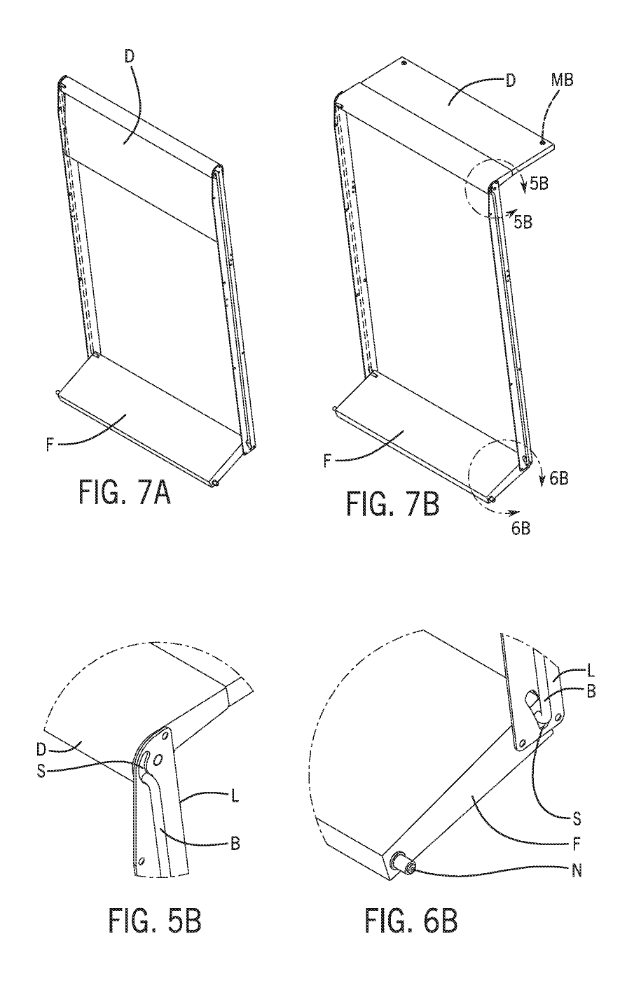

Referring to FIGS. 3A-3B, as shown schematically according to an exemplary embodiment, the receptacle (e.g. within the cabinet/structure) comprises a mechanism to actuate the flip door D by the foot pedal F providing a linkage with an actuator arms/members shown as a set of rods B secured/shielded by a set of cover plates L. See also FIG. 4C-4D (set of arms/plates at each lateral side of the interior volume of receptacle) and FIGS. 4E-4F (single arm/plate arrangement at one lateral side of interior volume of receptacle). As shown schematically in FIGS. 3A-3F, 4B-4F, 7A-7B and 8, according to an exemplary embodiment, the mechanism comprises a linkage with rod B coupled through cover plate L into flip door D at a top end and through cover plate L into foot plate F at a bottom end at each lateral side (e.g. the linkage comprises a rod attached at each side of the flip door/foot plate); as shown schematically in FIGS. 5A-5B, 6A-6B and 11F-11G, cover plate L provides a set of tracks or guides shown as curved slots S for guiding movement of each end (of each rod B) of the mechanism/arrangement on a path of travel in operation of the receptacle (e.g. in use of the foot pedal to actuate the flip door between open/closed stops). See also FIGS. 9A and 10.

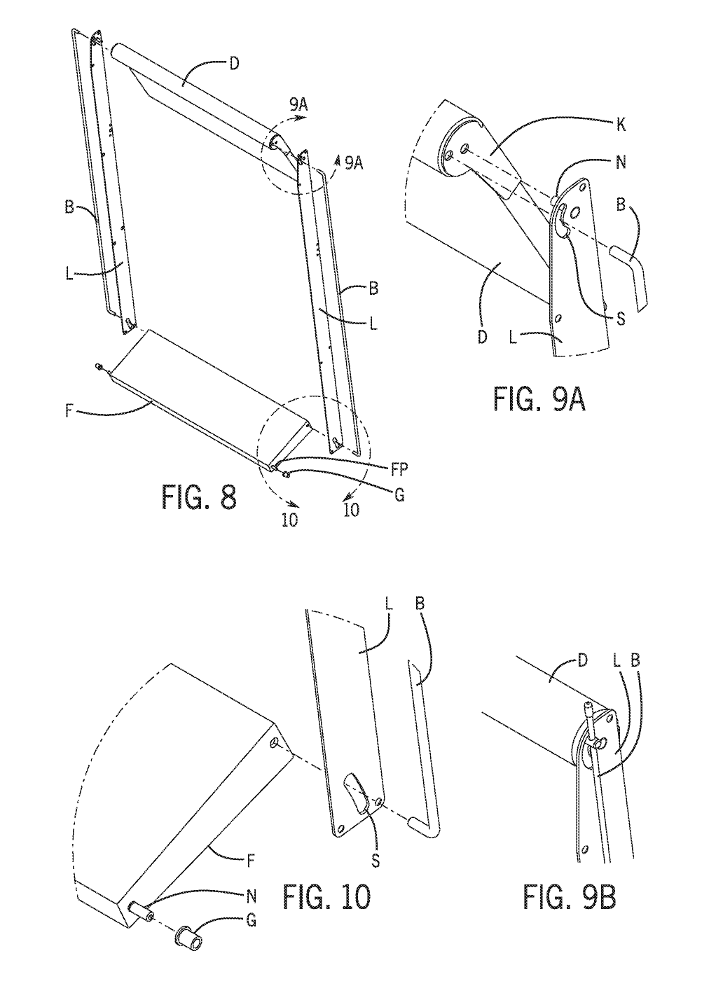

As indicated schematically in FIGS. 2C-2D and 11F-11G, actuation (e.g. downward pressure) on foot plate F actuates flip door D from the closed position (e.g. vertical orientation) to an open position (e.g. generally horizontal orientation) acting through rods B in a path of movement guided within slots S of each cover plate L. See also FIGS. 7A-7B and 11A-11G (showing actuation of foot pedal to pull the flip door into the open position). As indicated schematically in FIGS. 5A-5B, 6A-6B and 11F-11G, the form/curve of each slot S on each cover plate L guides the corresponding movement of the flip door D as the foot pedal F is actuated (e.g. through a path of travel to or between each stop/end of the slot). See also FIGS. 7A-7B and 11A-11E. As shown schematically in FIGS. 7A-7B and 11F-11G, pivot/hinge actuation of the foot plate F opens and closes flip door D by pivot/hinge action through the linkage arrangement with the rod B at ends guided in the slots S at the top/bottom of the cover plate L of the mechanism. See FIGS. 5A-5B and 6A-6B. See also FIGS. 8, 9A and 10. As shown schematically according to an exemplary embodiment in FIGS. 11F-11G, the actuation mechanism of the receptacle provides a slot S corresponding (e.g. concentric) to the pivot point DP for the flip door D (e.g. generally conforming radius/curvature of the guide/track of the slot for constrained movement of the arm/rod B) and a slot S corresponding (e.g. concentric) to the pivot point FP for the foot plate/pedal F (e.g. generally conforming radius/curvature of the guide/track of the slot for constrained movement of the arm/rod B) to provide intended/coordinated actuation/action for the flip door D through the foot pedal F. See also FIGS. 9A, 10, 11A-11E and 22A-22C. As shown schematically according to an exemplary embodiment in FIG. 9B, the linkage arrangement for the actuation mechanism may comprise a bolt/pin arrangement (e.g. attached with clamp/stop) to actuate the flip door from the closed position to the open position as the foot plate/pedal is actuated (or according to an alternative embodiment a cable/clamp arrangement, etc.).

As shown schematically according to an exemplary embodiment in FIGS. 3A and 4C-4F, each cover plate L is configured to provide shielding/covering for the linkage of the mechanism within the internal volume of the receptacle into which items of waste material are deposited (e.g. intended to prevent items from waste material from contact/exposure with the rod/linkage mechanism). See also FIGS. 3B-3F, 7A-7B and 8. As indicated schematically in FIGS. 3A-3F, 8 and 9A, the flip door D may be secured to the cabinet/structure of the receptacle by a pivot mount shown as pin N on the cover plate L (e.g. attached by welding, etc.) providing the pivot point DP for the flip door. According to an exemplary embodiment, cover plate L is installed/mounted to the cabinet/structure of the receptacle (e.g. in a recess PC of panel P at each side) as shown in FIGS. 3A, 3C, 3F and 4B-4F.

Operation of the receptacle according to an exemplary embodiment is shown schematically in FIGS. 11A-11E; the actuation of foot pedal F through a predetermined angular range actuates the flip door D through a corresponding angular range from a closed position (see FIG. 11A) to a fully open position (see FIG. 11E). As indicated schematically the closed position may comprise a generally vertical orientation of flip door D and the fully open position may comprise a generally horizontal position of flip door D (e.g. at or approximately 90 degrees (+/−) from the vertical closed position). As indicated schematically in FIGS. 11A through 11E, progressive movement or actuation at the foot pedal F will progressively move flip door D through a range of motion from the closed position to the open position. As indicated, when the foot pedal F is unactuated the flip door D will return to its vertical orientation or position. See FIG. 11A. As shown schematically in FIGS. 15A-15B and 16A-16B, the hinged/flip door D may operate on a pivot shown as axle DL and comprise a spring-assist mechanism or arrangement (shown as comprising a torsion spring W) to provide a biasing force tending to maintain the door in the closed position (e.g. vertical orientation) until the biasing force is overcome by actuation of the foot plate/pedal to move the door toward/to the open position.

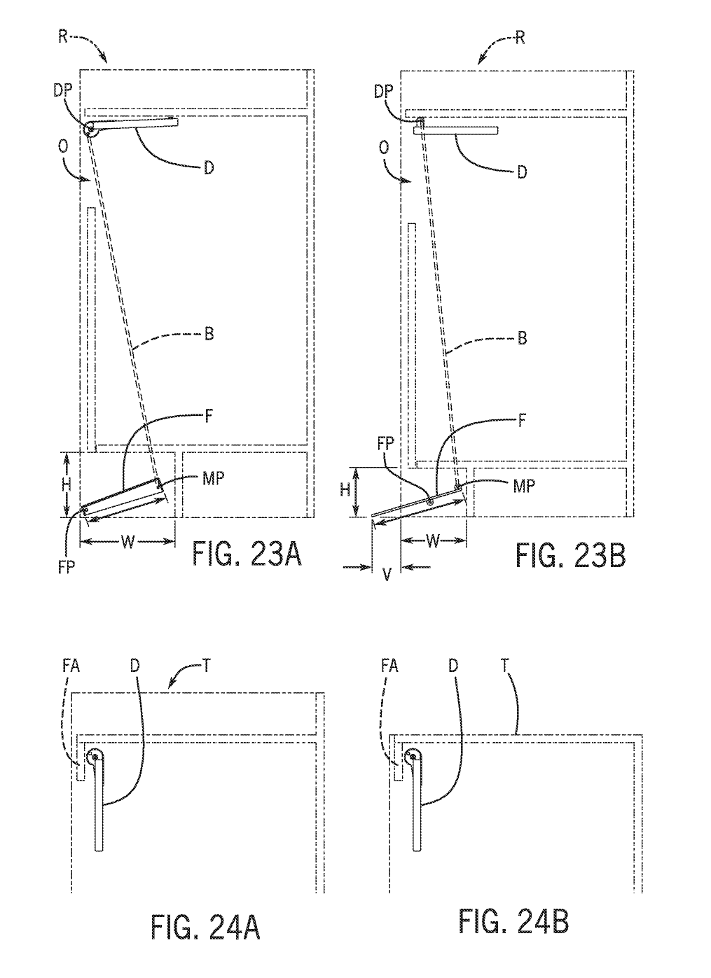

As indicated schematically in FIGS. 11A-11E and 23A, the foot pedal may be substantially contained within a space or envelope shown as a recess within the base of the cabinet/structure of the receptacle (e.g. as indicated as receptacle with height HR and width WR in FIG. 11A and with height H and depth W for the recess in FIG. 23A).

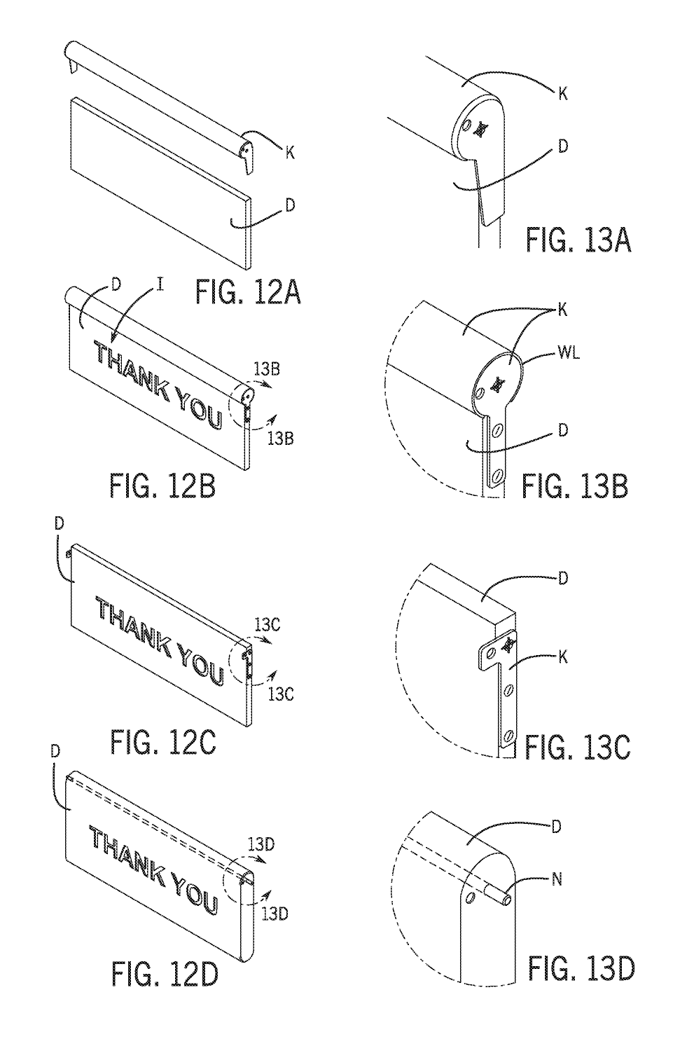

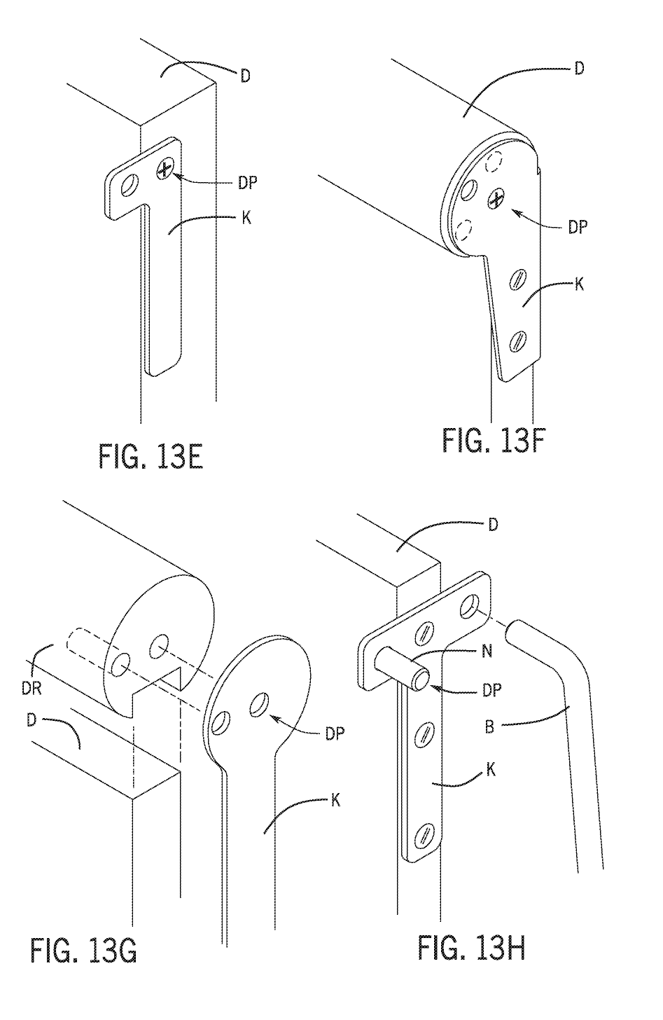

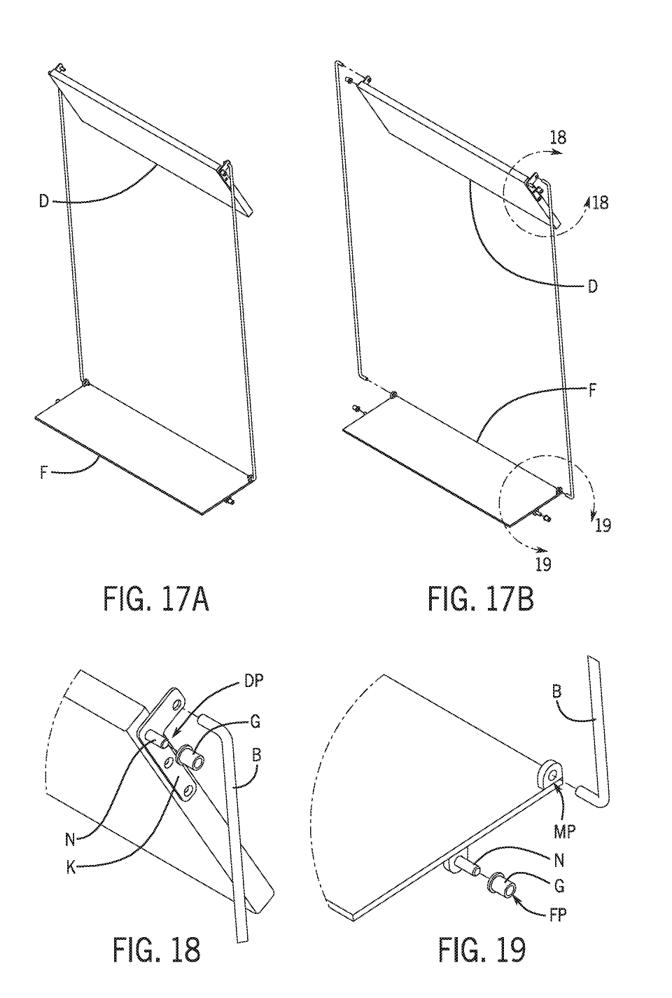

As indicated schematically according to an exemplary embodiment in FIGS. 12A-12D and 13A-13H, the flip door D may be provided in a variety of shapes/forms (e.g. such as a flat panel, enlarged body, panel with enlarged hinge section, composite body, multi-component assembly, etc.) and with a variety of different attachment/mounting arrangements to the cabinet/structure and actuation mechanism that correspond to the shape/form of the flip door and facilitate corresponding operation/use with the actuation mechanism (e.g. connected by linkage/rod to the foot plate/pedal); as indicated schematically, an attachment shown as bracket K (e.g. formed/attached or mounted by fasteners such as conventional screws, welding, adhesives, etc.) may be provided for the flip door (which hinges/pivots at a pin/axle providing a door pivot point DP) in a variety of forms and configurations—such as with a bracket K mounted over the structure/panel of the flip door with attachment point at an angular offset from the center/pivot mount of the flip door (see FIGS. 12A and 13A), with bracket K attached (such as by weld WL, etc.) to the structure of the flip door with attachment point at a side offset from the center/pivot mount of the flip door (see FIGS. 12B and 13B), with bracket K attached to the structure of the flip door as a plate/panel with side offset from the center/pivot mount for flip door (see FIGS. 12C and 13C), integrated with the body of the flip door (e.g. molded or formed as a single component with no separate bracket structure, etc.) (see FIGS. 12D and 13D), with a flat plate/attached bracket K (e.g. attached or mounted such as by fasteners, adhesive, welding, etc.) with an attachment point at a side offset and the pivot point DP for the flip door at a side offset (see FIG. 13E), with bracket K that may be provided with attachment points at selected/design locations to provide an angular/side offset from the pivot mount DP of the flip door (see FIG. 13F), with a flip door structure comprising a generally flat panel with a top/base (e.g. shown as a mating rod, dowel, etc.) and a flat bracket K assembled to the flip door structure (see FIG. 13G), with a bracket K such as a T-shaped attachment plate with side offset (see FIG. 13H). Compare FIGS. 7A-7B and 11A-11G (mechanism for pull operation) with FIGS. 17A-17B, 18 and 20A-20E (mechanism for push operation). As shown schematically in FIGS. 12A-12D and 13A-13H, the attachment point for the rod/cable of the linkage of the actuation mechanism may be provided at a variety of positions and orientations on the flip door or offset/relative to the flip door.

According to an exemplary embodiment as shown schematically in FIGS. 11A-11G and 13A-13H, modification of the configuration of the attachment of the linkage arrangement to the flip door (such as by bracket/attachment K) will facilitate adjustment of calibrated/coordinated actuation of the foot plate/pedal F (e.g. indicated by angle X) with movement of the flip door D from the closed position to the open position (e.g. indicated by angle Y); as indicated, modification/adjustment of the attachment of the flip door to the linkage arrangement (e.g. by variation of the offsets/attachment points to the flip door such as by configuration of the bracket) will facilitate implementation/optimization of the movement of the flip door upon actuation at the foot pedal (e.g. variation of leverage, intended force calibration, ease of use, etc.).

As shown schematically in FIGS. 8, 12A-12B and 12D and 13F-13G, the flip door may be provided with a profile/shape (e.g. shown as a curved profile to fit into the opening) and construction to reduce the potential of a “pinch” hazard at the opening into the receptacle; as shown schematically in FIGS. 12C, 13E and 13H, the flip door may comprise a flat/panel form. As indicated schematically in the FIGURES, the flip door/assembly may be provided with a mass balance (e.g. weight distribution, counterweight, eccentric form, offset, etc.) intended to facilitate operation/actuation and convenient use. See e.g. FIGS. 11F-11G, 12A-12B and 13E. As shown schematically in FIGS. 12B-12D, the flip door may be provided with indicia such as text/words and/or symbols providing guidance, user directions or other messaging/communication. See also FIG. 1F (access door provided with indicia).

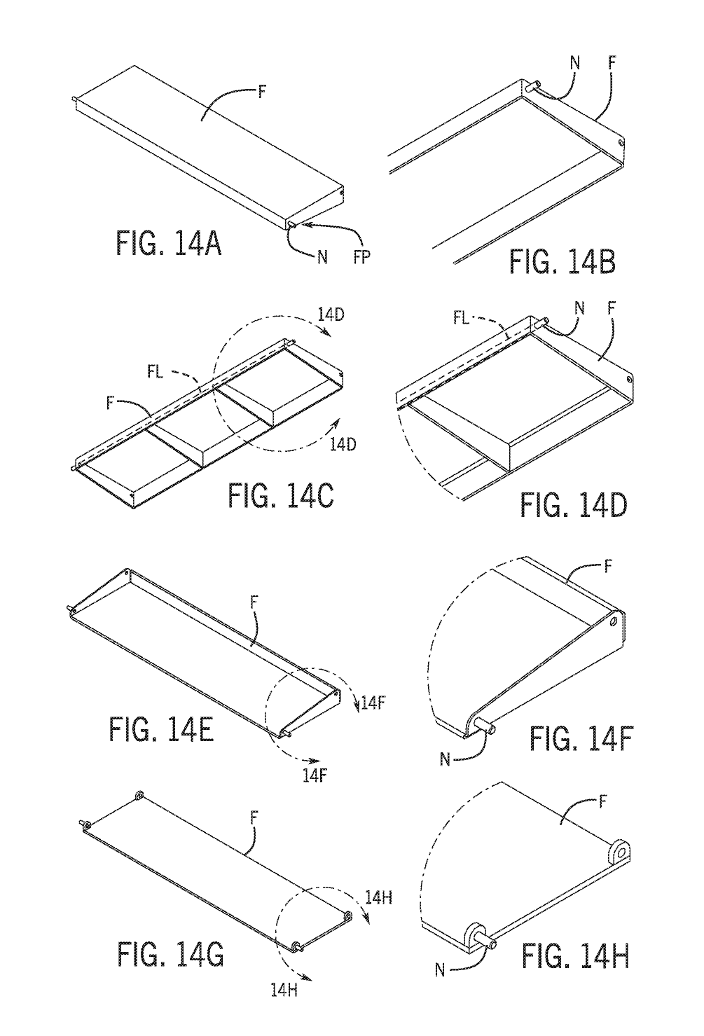

Referring to FIGS. 14A-14H, as shown schematically according to an exemplary embodiment the foot plate F of the receptacle may be provided in a variety of sizes/widths and forms/arrangements; according to an exemplary embodiment the foot plate F will substantially span the interior width of the face/front of the cabinet (e.g. in generally the same width of the corresponding hinged/flip door of the receptacle). See also FIGS. 1A-1F, 2A-2B and 4A. As indicated schematically in FIGS. 14A, 14E and 14G, the foot plate F will provide a generally flat top surface for the foot of the user to actuate/operate the flip door and an axle and/or pin N for mounting/attachment to the cabinet/structure (e.g. in a pivot mount and/or bearing) and attachment points (shown as apertures) for the linkage to the hinged/flip door. See also FIGS. 1F and 2C-2D and 11A-11G. As shown schematically according to an exemplary embodiment in FIGS. 14A-14D, the foot pedal may comprise a shell/structure that is open (see FIG. 14B) or that is reinforced with webs/gussets or other rigidification structure (see FIGS. 14C and 14D). As indicated schematically according to an exemplary embodiment in FIGS. 14E and 14F, the foot pedal may comprise a shell/structure with extended sidewalls (e.g. formed walls, folded walls, etc.). As shown schematically according to an exemplary embodiment in FIGS. 14G and 14H, the foot pedal may comprise a generally flat panel/structure with flanges or tabs to provide attachment points to the linkage arrangement and flanges or tabs for the pins/pivot for mounting points to the cabinet structure.

As shown schematically according to an exemplary embodiment in FIGS. 3A-3B, 4B-4C, 5A-5B, 6A-6B and 7A-7B, the actuation mechanism of the receptacle may be configured to “pull” the flip door from the closed position to the open position as the foot plate/pedal is actuated. See also FIGS. 11A-11F and 23A. Operation of the “pull” actuation mechanism for the receptacle is indicated schematically in FIGS. 11A through 11E; actuation of the foot pedal (through a range indicated as angle X) moves the flip door (through a range indicated as angle Y) from the generally vertical orientation (see FIG. 11A) to an open position (see FIG. 11E). See also FIGS. 2C-2D and 11F-11G. According to an exemplary embodiment indicated schematically in FIGS. 11A-11E, when the receptacle is not in use/actuation (e.g. default position) the flip door is at a default vertical orientation (Y at 0 degrees reference) and the foot pedal is at a default angular orientation (X of approximately 25 degrees) relative to horizontal orientation; in operation as indicated, the flip door pivots/swings toward the open position as the foot pedal is depressed (e.g. X of approximately 22 degrees and Y of approximately 24 degrees); the flip door pivots further toward the open position as the foot pedal is depressed further (e.g. X of approximately 20 degrees and Y of approximately 48 degrees); the flip door pivots further toward the open position as the foot pedal is depressed further (e.g. X of approximately 17 degrees and Y of approximately 72 degrees); the flip door pivots to the open position as the foot pedal is depressed more fully (e.g. X of approximately 16 degrees and Y of approximately 92 degrees) (e.g. constrained at the stop with approximately 9-10 degrees of movement of the foot pedal effecting approximately 90 degrees of movement of the flip door); upon release of the foot pedal, the flip door and foot pedal return to the default position/orientation (e.g. constrained at the stop position). See also FIGS. 11F-11G. As indicated schematically in FIGS. 11A-11E, the foot pedal may be substantially contained within a space or envelope within the base of the cabinet/structure of the receptacle. See also FIG. 23A (e.g. space indicated with height H and depth W). As shown schematically according to an exemplary embodiment, the receptacle may be provided with an actuation mechanism for the flip door through the foot plate/pedal that comprises a single arm/rod (e.g. lever) or a dual set of arms/rods. Compare FIGS. 4B-4C and 4E-4F.

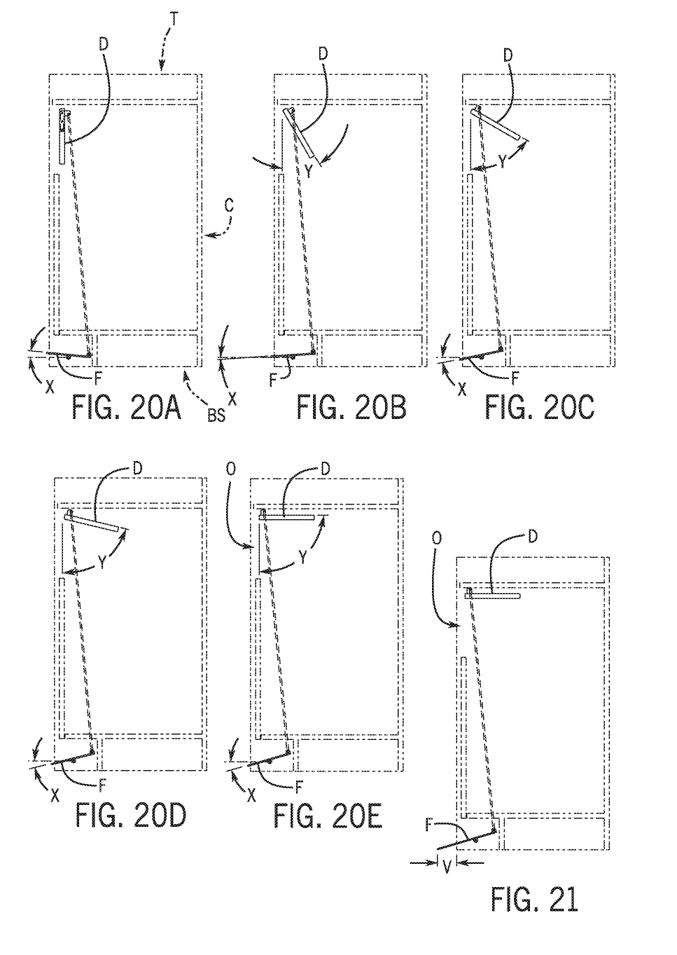

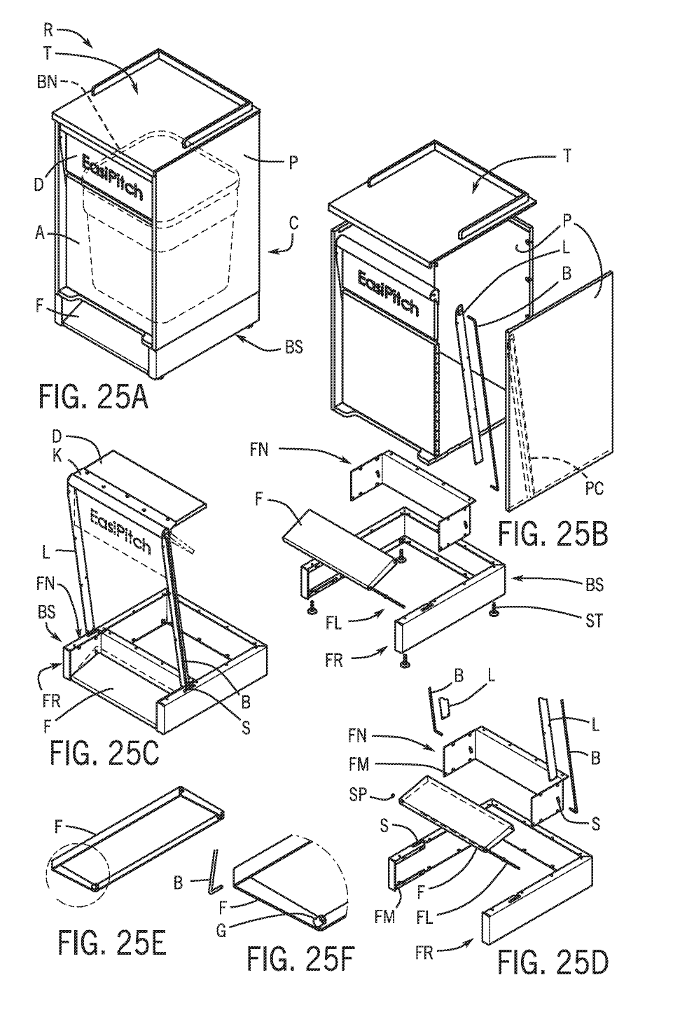

As shown schematically according to an exemplary embodiment in FIGS. 17A-17B, 18 and 19, the actuation mechanism of the receptacle may be configured to “push” the flip door from the closed position to the open position as the foot plate/pedal is actuated. See also FIGS. 20A-20E and 23B. As indicated schematically according to an exemplary embodiment in FIGS. 17A-17B, 18 and 19, the mechanism may comprise a member/rod shown as push rod B which facilitates movement of the flip door D from the closed (e.g. generally vertical) position to the open (generally horizontal) position upon actuation at foot plate F. See also FIGS. 20A-20E. As indicated schematically in FIGS. 17A-17B and 18, the rod B of the linkage mechanism may engage a mounting hole in bracket K to couple the flip door D to the foot plate/pedal F; the flip door D provides a pin N in bearing G for mounting to the cabinet/structure of the receptacle. As indicated schematically in FIGS. 17A-17B and 19, the rod B of the linkage may engage a mounting hole on a flange to couple to the foot plate/pedal F; the foot plate/pedal provides a pin N in bearing G for mounting to the cabinet/structure of the receptacle. Operation of the “push” actuation mechanism for the receptacle is indicated schematically in FIGS. 20A through 20E; actuation of the foot pedal (through a range indicated as angle X) moves the flip door (through a range indicated as angle Y) from the generally vertical orientation (see FIG. 20A) to an open position (see FIG. 20E). According to an exemplary embodiment indicated schematically in FIGS. 20A-20E, when the receptacle is not in use/actuation (e.g. default position) the flip door is at a default vertical orientation (Y at 0 degrees reference) and the foot pedal is at a default angular orientation (X of approximately +5 degrees) relative to horizontal orientation; in operation as indicated, the flip door pivots/swings toward the open position as the foot pedal is depressed (e.g. X of approximately −4 degrees and Y of approximately 30 degrees); the flip door pivots further toward the open position as the foot pedal is depressed further (e.g. X of approximately −12 degrees and Y of approximately 60 degrees); the flip door pivots to the open position as the foot pedal is depressed more fully (e.g. X of approximately −16 degrees and Y of approximately 90 degrees) (e.g. constrained at the stop with approximately 20-21 degrees of movement of the foot pedal effecting approximately 90 degrees of movement of the flip door); upon release of the foot pedal, the flip door and foot pedal return to the default position/orientation (e.g. constrained at the stop position). As indicated schematically in FIGS. 20A-20E and 25A-25C, the foot pedal may be substantially contained within a space or envelope within the base of the cabinet/structure of the receptacle; as shown schematically in FIGS. 21 and 23B the foot plate of the cabinet may extend slightly outward from the cabinet (e.g. as indicated by distance V from the space indicated with height H and depth W).

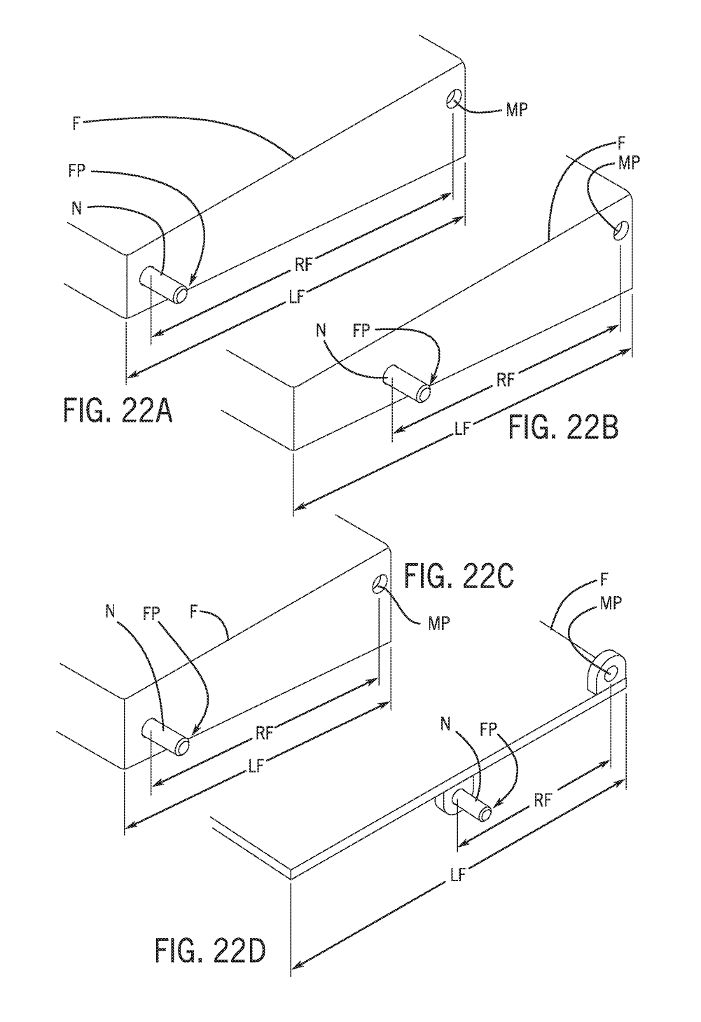

According to an exemplary embodiment, actuation/action of the flip door with the mechanism may be modified by design/configuration of the foot plate/pedal and design/configuration of the flip door (e.g. sizing of components, arrangement of pivot points, attachment points with linkage/rod B, etc.); as indicated schematically, the receptacle may be designed to provide actuation/action between the foot pedal and flip door with a varying degree of travel/opening (e.g. approaching or greater than 90 degrees open), sensitivity/optimization (e.g. correlation of travel of the foot pedal to actuation of the flip door, degree of force for actuation, placement/height of foot pedal, etc.), size/fit within and/or below the cabinet/structure (e.g. within the base/footprint of the cabinet, extending from the base, etc.), force/weight and mass properties (e.g. weight of flip door, mass of mechanism, center of gravity/mass, use of springs/counterweights, inertia, eccentricity/offset, etc.). See FIGS. 11A-11F, 13D-13H, 18, 20A-20E, 22A-22D and 23A-23B. As indicated schematically according to an exemplary embodiment in FIGS. 22A-22C, the mounting/pivot arrangement and foot pedal configuration may be modified to adjust the correlation between movement of the foot pedal and movement of the flip door (e.g. corresponding relative distance/angle of travel of the flip door in response to movement of the foot pedal). See also FIGS. 11A-11G. As indicated schematically, the foot pedal F has a length LF (which may be provided in a greater length as shown in FIG. 22A or a shorter length as shown in FIG. 22C) to adjust to design intent or constraints (such as toe space). See also FIG. 23A. As indicated schematically, the foot pedal F is attached to the cabinet/structure by pin N at a fixed pivot point FP; the foot pedal F is attached to the linkage (e.g. rod, lever arm, etc.) at attachment point MP; the distance RF between the linkage attachment point MP and the pivot pin N may be adjusted to optimize/adjust the effect of movement of the foot pedal F on movement of the flip door D through the range of motion (e.g. distance shortened to reduce sensitivity and lengthened to enhance sensitivity, as may allow variation in ease of use, etc.); as indicated, modification/adjustment of the attachment of the foot pedal to the linkage arrangement (e.g. by variation of distance RF or length LF of foot pedal) will facilitate implementation/optimization of the movement of the flip door upon actuation at the foot pedal. Compare FIGS. 22A-22B and 22C-22D.

According to an exemplary embodiment as shown schematically in FIGS. 25A-25F, a receptacle/apparatus R for waste material comprises a body shown as cabinet C and a base BS and a top T with a door shown as flip door D providing access into an interior space providing a bin BN (e.g. container for items of waste material deposited through door D) manually actuated by an actuator shown as pedal/foot pedal F provided in a recess in base BS (e.g. at/under bottom of the cabinet). See also FIGS. 1A-1F and 2A-2F. As indicated schematically in FIGS. 25A-25C, actuation of the foot pedal F will operate the door D through a link assembly shown as comprising link member B (e.g. coupled to foot pedal F and bracket K/door D). See also FIGS. 2C-2D and 11A-11G (e.g. pivoting movement of foot pedal at a fulcrum within the recess in the base between a default position and an actuated position operates directly through a link assembly comprising a rigid member/rod to pull/pivot the door from a closed position toward the open position).

As shown schematically in FIGS. 25A-25D according to an exemplary embodiment, the link assembly comprising member B is configured to couple the foot pedal/actuator F to the door D within the cabinet C; as shown, the side panel/wall P of the cabinet/body C comprises a recess PC into which the link/link assembly is at least partially installed behind a frame member shown as cover plate L. See also FIGS. 3A-3F (e.g. showing assembly/attachment of member/rod B to bracket K/door D and link/link assembly within recess PC behind frame member/cover plate L). As shown schematically in FIGS. 25B-25D according to an exemplary embodiment, the base BS comprises an assembly providing a frame FR and a frame insert FN. (As shown schematically the base/frame may also comprise a set of stands/levelers ST.) As shown schematically, the cabinet C is installed onto the frame FR of base BS (see FIGS. 25A-25B) and the link assembly/link comprising member B with frame member/cover plate L is installed into the frame insert FN of the base BS (e.g. through slot S in frame insert FN and slot S in frame FR assembled adjacent to recess PC in panel P of cabinet C) (see FIGS. 25C-25D); the foot pedal F is installed into a mount FM for axle FL (e.g. with bearing/bushing G and spacer SP) in frame FR and frame insert FN of base BS (see FIGS. 25C-25F). As indicated schematically according to an exemplary embodiment in FIGS. 25C-25D, the link assembly comprises a dual link assembly coupling each side of the door D to each side of the foot pedal F (e.g. in a generally symmetrical arrangement) so that manual pivotal actuation of the foot pedal F from the default position to the actuated position will move the door D from the closed position (e.g. generally vertical) toward the open position (e.g. generally horizontal). See also FIGS. 2C-2D, 4C-4D, 11A-11G, 20A-20E and 23A-23B.

As indicated schematically in FIGS. 25A-25B, the receptacle/apparatus is configured for convenient use in any of a wide variety of environments. See also FIGS. 1A-1F, 11A-11G and 20A-20E.

### EXEMPLARY EMBODIMENTS

According to an exemplary embodiment shown schematically, a receptacle for waste material may comprise a top; a body configured to provide an interior; a base for the body configured to provide a recess; a door under the top configured to move between a closed position and an open position to facilitate access into the interior of the body; an actuator mounted in the recess of the base and configured to move between a default position and an actuated position and a link coupling the actuator to the door. See for example FIGS. 1A-1E, 2A-2F, 4A-4F, 8, 11A-11G, 17A-17B, 20A-20E, 21, 23A-23B, 24A-24B and 25A-25C.

According to an exemplary embodiment shown schematically, the actuator may be configured for manual actuation to move between the default position and the actuated position to move the door from the closed position toward the open position so that waste material may be deposited within the interior of the body. See for example FIGS. 1A-1F, 2A-2F. 3A. 4A-4F. 12A-12D, 14A-14H, 15A-15B and 25A-25B.

According to an exemplary embodiment shown schematically, the door of the receptacle may comprise a flip door pivotally coupled to the body and configured to pivot from a generally vertical orientation in the closed position toward the interior of the body to the open position. See for example FIGS. 1A-1F, 2B-2D, 4A-4F, 8, 11A-11G, 17A-17B, 20A-20E, 21, 23A-23B, 24A-24B and 25A-25C. According to an exemplary embodiment shown schematically, the actuator may comprise a plate at least partially within the recess and pivotally coupled to the base; the actuator may comprise a foot pedal in the recess in the base and pivotally coupled within the base. See for example FIGS. 2C-2D, 4A-4F, 11A-11E, 20A-20E, 21, 23A-23B and 25A-25C.

According to an exemplary embodiment shown schematically, the link may comprise a member coupled at one end to the foot pedal and coupled at one end to the door; the member may comprise a rigid member configured to couple the foot pedal directly to the door. See for example FIGS. 3A-3B, 4B-4F, 7A-7B, 8, 9A-9B, 10, 11A-11F, 17A-17B, 20A-20E, 21, 23A-23B, and 25B-25D. According to an exemplary embodiment shown schematically, the member may comprise a post configured to engage a side of the door and a post configured to engage a side of the foot pedal. See for example FIGS. 3B-3F, 5A-5B, 6A-6B, 7A-7B, 8, 9A-9B, 10, 12A-12D, 13A-13H, 14A-14H, 17A-17B, 18, 19, 22A-22D, 23A-23B and 25B-25F.

According to an exemplary embodiment shown schematically, the receptacle may comprise a frame member providing a slot; the post of the member configured to engage the side of the door may extend through the slot. See for example FIGS. 3A-3C, 4B, 5A-5B, 6A-6B, 8, 9A-9B, 10, 11F-11G and 25B-25D.

According to an exemplary embodiment shown schematically, the receptacle may comprise a frame member providing a slot; the link may comprise a member coupled at one end to the foot pedal and coupled at one end to the door; the end of the member coupled to the foot pedal may extend through the slot of the frame member. See for example FIGS. 3B-3F, 5A-5B, 6A-6B, 7A-7B, 8, 9A-9B, 10, 12A-12D, 13A-13H, 14A-14H, 17A-17B, 18, 19, 22A-22D, 23A-23B and 25B-25F.

According to an exemplary embodiment shown schematically, the receptacle may comprise a body providing a side panel; the side panel may comprise a recess for the link; the link may comprise a member at least partially within the recess of the side panel; the receptacle may comprise a cover plate at least partially covering the recess for the link in the side panel of the body. See for example FIGS. 3A-3F, 4A-4F and 25A-25D.

According to an exemplary embodiment shown schematically, the body may comprise an access door under the flip door configured to facilitate access to a bin for waste material within the interior of the body. See for example FIGS. 2A-2F, 3A, 4A-4F and 25A-25B.

According to an exemplary embodiment shown schematically, the base may comprise a frame. See for example FIGS. 1A-1E, 2A-2F, 4A-4F and 25A-25D. According to an exemplary embodiment shown schematically, the body may comprise a cabinet comprising at least one of a wood material; a metal material; a plastic material; the base may comprise at least one of a metal frame; a wood material; and the top may comprise at least one of a wood material; resin material. See for example FIGS. 1A-1E, 2A-2F and 25A-25C. According to an exemplary embodiment, the cabinet/body, base and top could be made of any of one or a combination of materials including but not limited to wood, wood material, metal, solid surface (e.g. resin, mineral, etc.), stone, masonry, plastic (e.g. resin, polymer material, recycled, partial recycled, etc.), ceramic/glass (e.g. glass material, recycled glass, etc.), etc. suitable for use in the intended environment.

According to an exemplary embodiment shown schematically, a receptacle for waste material may comprise a top, a body configured to provide an interior, a base for the body configured to provide a recess, a door under the top configured to pivot from a generally vertical orientation in the closed position to an open position toward the interior of the body to facilitate access into the interior of the body, a foot plate coupled in the recess of the base and configured to pivot between a default position and an actuated position and a link assembly coupling the foot plate to the door. See for example FIGS. 1A-1E, 2A-2F, 4A-4F, 8, 11A-11G, 17A-17B, 20A-20E, 21, 23A-23B, 24A-24B and 25A-25C.

The foot plate may be configured for manual actuation to pivot between the default position and the actuated position to pivot the door from the closed position toward the open position so that waste material may be deposited within the interior of the body. See for example FIGS. 1A-1F, 2A-2F. 3A. 4A-4F. 12A-12D, 14A-14H, 15A-15B and 25A-25B. The link assembly may comprise a rigid member directly coupling the foot plate to the door and comprising a frame member for the rigid member. See for example FIGS. 3A-3C, 0.4B-4D, 7A-7B, 8, 11A-11G, 17A-17B, 20A-20E, 21, 23A-23B and 25A-25B.

According to an exemplary embodiment shown schematically, the link assembly may comprise a first member providing an end configured to engage a first side of the door and an end configured to engage a first side of the foot plate and a second member providing an end configured to engage a second side of the door and an end configured to engage a second side of the foot plate. See for example FIGS. 3A-3B, 4A-4F, 7A-7B, 17A-17B and 25A-25D.

According to an exemplary embodiment, an apparatus for depositing waste material may comprise a top, a cabinet comprising at least one side panel and configured to provide a body having an interior configured for a bin, a base under the body configured to provide a recess, a door under the top configured to pivot from a generally vertical orientation in the closed position to an open position toward the interior of the body to facilitate access into the interior of the body, a foot plate coupled to the base in the recess and configured to pivot between a default position and an actuated position and a link assembly coupling the foot plate to the door. See for example FIGS. 1A-1E, 2A-2F, 4A-4F, 8, 11A-11G, 17A-17B, 20A-20E, 21, 23A-23B, 24A-24B and 25A-25D. The link assembly may comprise a member installed at least partially within a recess in the side panel of the cabinet. See for example FIGS. 3A-3F, 4A-4F and 25A-25D. The foot plate may be configured for manual actuation to pivot between the default position and the actuated position to pivot the door from the closed position toward the open position so that waste material may be deposited into the bin within the interior of the body. See for example FIGS. 1A-1F, 2A-2F, 4A-4F, 7A-7B, 11A-11G. 17A-17B, 20A-20E, 21, 23A-23B, 24A-24B and 25C.

According to an exemplary embodiment shown schematically, the apparatus may comprise a cover plate at least partially covering the recess for the member of the link assembly in the side panel of the cabinet. See for example FIGS. 3A-3F, 4A-4F and 25A-25D.

According to an exemplary embodiment shown schematically, the member of the link assembly may comprise a rod providing an end configured to engage a side of the door and an end configured to engage a side of the foot plate. According to an exemplary embodiment shown schematically, the foot plate may comprise a pedal pivotally coupled to the base on an axle; the door may comprise a flip door pivotally coupled to the base on an axle. See for example FIGS. 1A-1F, 2A-2D, 11A-11G, 12A-12D, 13A-13D, 14A-14A, 15A-15B, 20A-20E, 22A-22D, 24A-24B and 25B-25F.

It is important to note that the construction and arrangement of the elements of the inventive concepts and inventions as described in the present application and as shown in the FIGURES is illustrative only. Although some embodiments of the present inventions have been described in detail in the present application/disclosure, those skilled in the art who review the present application/disclosure will readily appreciate that many modifications are possible without materially departing from the novel teachings and advantages of the subject matter of the disclosure. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

It is important to note that the structure/system and method of the present inventions may comprise conventional technology (e.g. as implemented in present configuration) or any other applicable technology (present or future) that has the capability to perform the functions and processes/operations indicated in the FIGURES. All such technology is considered to be within the scope of the present inventions and application.

The invention claimed is:

1. A receptacle for waste material comprising:
(a) a top;
(b) a body configured to provide an interior;
(c) a base for the body configured to provide a recess;
(d) a door under the top configured to move between a closed position and an open position to facilitate access into the interior of the body;
(e) an actuator mounted in the recess of the base and configured to move between a default position and an actuated position;
(f) a link coupling the actuator to the door;
wherein the actuator is configured for manual actuation to move between the default position and the actuated position to move the door from the closed position toward the open position so that waste material may be deposited within the interior of the body.

2. The receptacle of claim 1 wherein the door comprises a flip door pivotally coupled to the body and configured to pivot from a generally vertical orientation in the closed position toward the interior of the body to the open position; and wherein the actuator comprises a plate at least partially within the recess and pivotally coupled to the base.

3. The receptacle of claim 1 wherein the actuator comprises a foot pedal in the recess in the base and pivotally coupled within the base.

4. The receptacle of claim 3 wherein the link comprises a member coupled at one end to the foot pedal and coupled at one end to the door.

5. The receptacle of claim 4 wherein the member comprises a rigid member configured to couple the foot pedal directly to the door.

6. The receptacle of claim 4 wherein the member comprises a post configured to engage a side of the door and a post configured to engage a side of the foot pedal.

7. The receptacle of claim 6 further comprising a frame member providing a slot; and wherein the post of the member configured to engage the side of the door extends through the slot.

8. The receptacle of claim 3 further comprising a frame member providing a slot; wherein the link comprises a member coupled at one end to the foot pedal and coupled at one end to the door; and wherein the one end of the member coupled to the foot pedal extends through the slot of the frame member.

9. The receptacle of claim 1 wherein the body comprises a side panel; wherein the side panel comprises a recess for the link; wherein the link comprises a member at least partially within the recess of the side panel.

10. The receptacle of claim 9 further comprising a cover plate at least partially covering the recess for the link in the side panel of the body.

11. The receptacle of claim 2 wherein the body comprises an access door under the flip door configured to facilitate access to a bin for waste material within the interior of the body.

12. The receptacle of claim 1 wherein the base comprises a frame.

13. The receptacle of claim 1 wherein the body comprises a cabinet comprising at least one of (a) a wood material; (b) a metal material; (c) a plastic material; wherein the base comprises at least one of (a) a metal frame; (b) a wood material; and wherein the top comprises at least one of (a) a wood material; (b) resin material.

14. A receptacle for waste material comprising:
(a) a top;
(b) a body configured to provide an interior;
(c) a base for the body configured to provide a recess;
(d) a door under the top configured to pivot from a generally vertical orientation in the closed position to an open position toward the interior of the body to facilitate access into the interior of the body;
(e) a foot plate coupled in the recess of the base and configured to pivot between a default position and an actuated position;
(f) a link assembly coupling the foot plate to the door;
wherein the foot plate is configured for manual actuation to pivot between the default position and the actuated position to pivot the door from the closed position toward the open position so that waste material may be deposited within the interior of the body.

15. The receptacle of claim 14 wherein the link assembly comprises a rigid member directly coupling the foot plate to the door and comprising a frame member for the rigid member.

16. The receptacle of claim 14 wherein the link assembly comprises (1) a first member providing an end configured to engage a first side of the door and an end configured to engage a first side of the foot plate and (2) a second member providing an end configured to engage a second side of the door and an end configured to engage a second side of the foot plate.

17. An apparatus for depositing waste material comprising:
(a) a top;
(b) a cabinet comprising at least one side panel and configured to provide a body having an interior configured for a bin;
(c) a base under the body configured to provide a recess;
(d) a door under the top configured to pivot from a generally vertical orientation in the closed position to an open position toward the interior of the body to facilitate access into the interior of the body;
(e) a foot plate coupled to the base in the recess and configured to pivot between a default position and an actuated position;
(f) a link assembly coupling the foot plate to the door;
wherein the link assembly comprises a member installed at least partially within a recess in the side panel of the cabinet;
wherein the foot plate is configured for manual actuation to pivot between the default position and the actuated position to pivot the door from the closed position toward the open position so that waste material may be deposited into the bin within the interior of the body.

18. The apparatus of claim 17 further comprising a cover plate at least partially covering the recess for the member of the link assembly in the side panel of the cabinet.

19. The apparatus of claim 17 wherein the member of the link assembly comprises a rod providing an end configured to engage a side of the door and an end configured to engage a side of the foot plate.

20. The apparatus of claim 17 wherein the foot plate comprises a pedal pivotally coupled to the base on an axle; wherein the door comprises a flip door pivotally coupled to the base on an axle.
